(19) United States
(12) Patent Application Publication
(10) Pub. No.: US 2026/0226570 A1
(43) Pub. Date: Aug. 6, 2026

(54) PROCESS OF DIRECT REDUCTION OF IRON ORES BY MEANS OF SYNTHESIS GAS PRODUCED WITH CATALYTIC PARTIAL OXIDATION

(71) Applicant: NEXTCHEM S.P.A., Roma (IT)

(72) Inventors: Luca Basini, Milano (IT); Gaetano Iaquaniello, Roma (IT); Francesco Barbetti, Roma (IT)

(21) Appl. No.: 19/152,083

(22) PCT Filed: Feb. 7, 2023
(86) PCT No.: PCT/EP2023/052943

§ 371 Date: Jul. 30, 2025

(51) Int. Cl. C21B 13/14; C21B 13/00; C21B 13/02

(52) U.S. Cl. CPC C21B 13/14; C21B 13/0073; C21B 13/023; C21B 2100/22; C21B 2100/26; C21B 2100/282

(57) ABSTRACT

A catalytic partial oxidation technology (CPO) is advantageously utilized in the direct reduction (DR) of iron ores for improving its energy efficiency and particularly for reducing the greenhouse gas (GHG) emissions. This CPO technology can utilize several gaseous hydrocarbon sources and allows the recycling of all the Direct Reduction Gas (DRG). The process also allows avoiding fire pre-heaters and heaters and allows the confinement of the CO₂ molecules inside the process stream from which they can be advantageously captured. The process also includes the use of O₂, H₂ and CO streams produced with electrolytic means for increasing the electrification of the DR process and for allowing further improvements of its sustainability. The CPO technology for producing syngas can also use the Blast Furnace Gases (BFG) and the Coke Oven Gases (COG) produced in the Iron Ores cycles utilizing the Blast Furnaces (BF), and this sustains the possibility of system integration between DR and BF processes.

### BACKGROUND OF THE INVENTION

The direct reduction of the Iron ores (Direct Reduction “DR”) is achieved by reacting synthesis gas (“syngas”, which is a mixture with a high content of H₂ and CO) with pre-shaped minerals typically inside a moving bed reactor. Here the Iron ores are reduced but the metal Iron does not reach the melting point and the product has a spongy shape (“Sponge Iron”) with a metal content greater than 92% and a carbon content less than 2%.

The sponge Iron pellets, also including non-ferrous components, are then processed with an Electrical Arc Furnace (“EAF”), a treatment that can also be carried out at sites other than those where the DR stage took place.

Noteworthy, this DR process does not use coke and for this reason is much less impactful than the process using the Blast Furnace (“BF”) solutions, but it is currently less widespread (approx. 7% of world iron and steel production is obtained by this method).

However, due to sustainability concerns, its use is rapidly growing and there are already several plants with a relatively high production capacity of more than 2.5 Mton per year (MTPY). It also noted that in some process solutions, the Direct Reduced Iron (“DRI”), in the form of Hot Briquette Iron (“HBI”), is also introduced into a blast furnace charge together with the Iron minerals and coke. This in some ways integrates the Direct Reduction and Blast Furnace routes. Overall, the Direct Reduction combined with the Electric Arc Furnace route is more energy efficient and consumes ca. the 75% of the energy consumed with the Blast Furnace combined with the Blast Oxygen Furnace (“BOF”) route while it produces a much lower amounts of pollutants and CO₂.

The technology of the company MIDREX is currently the most representative in this area. It utilizes a DR furnace including a mobile bed of Iron ores and a hot syngas flow that is produced by a steam —CO₂ reformer and that is flowed countercurrent with respect to the Iron ores motion. The steam —CO₂ reforming reactor typically operates at low pressure (approx. 2.5-3.0 kg/cm²g) and high temperature (typically above 850° C.) with a low steam content and a high CO₂ content in the feedstock.

Since the DR reactors consume approx, the 50% per pass of the H₂ and CO included in the synthesis gas, there is the necessity of a substantial recycle and reuse of the unconverted synthesis gas both as a reagent in the steam —CO₂ reforming tubes and as a fuel in the steam-CO₂ reforming furnace.

The composition of the recycled synthesis gas, and in general the integration between the syngas production unit and syngas utilization in the DR, is therefore a key aspect for increasing the energy efficiency of the overall DR process and hence for reducing its CO₂ emissions. FIG. 1 shows a simplified block diagram of a current process solution utilized for reducing the iron ores with a DR unit. The figure also highlights three major emission points of Green House Gases (“GHG”) that are produced with this process.

With reference to FIG. 1, fine high grade iron ores 10, typically with an iron content of 66 weight %, and lump ores 12, typically with a size of 7-25 mm, are fed from the top of a shaft furnace 14. Synthesis gas is introduced through tuyeries 16 at the top half of the furnace. The syngas reacts in a countercurrent flow with the iron ores and direct-reduces them to sponge iron 11, which is cooled in the bottom half of the shaft before being discharged. Cooling is achieved by withdrawing hot gases from the bottom half of the shaft furnace 14, passing them through a cooling circuit 15 and re-introducing them at the bottom of the shaft via a line 15a.

The syngas is produced in a steam —CO₂ reformer 18 and fed to the tuyeries 16 via a line 17. Unconverted synthesis gas, together with the CO₂-rich stream produced in the DR reactor, which is named Direct Reduction Gas (“DRG”), is withdrawn from the top of shaft 14 via a line 19. A part of this DRG is recycled as a reagent in the steam —CO₂ reformer via line 21 by means of a compressor 32, and a part is sent via line 23 to the steam —CO₂ reforming furnace to be used as fuel.

Natural gas is fed through line 25 to a feedstock pre-heater 20, from which it, discharged into a line 27, mixed with steam and CO₂ fed from a line 29 and introduced into the steam —CO₂ reformer 18.

With respect to the three major emission points of Green House Gases (“GHG”) that are produced in this process, it is noted that the first (point A) is associated with the emissions of the steam —CO₂ reforming furnace 18, the second (point B) is associated with the flue gas of the feedstock pre-heating furnace 20, and the third (point C) is due to the purge 9 of the recycled CO₂-rich stream produced in the DR reactor. This CO₂-rich stream is named Direct Reduction Gas (“DRG”).

Equations [1-4]represent the main reactions occurring inside the di DR reactor.

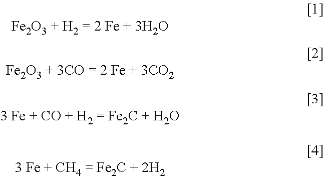

Hematite (Fe₂O₃) has an Iron content between 50-65%; and non-magnetic behavior and is the starting mineral and the most easily reducible compound. Magnetite (Fe₃O₄) contains a combination of ferric oxide and ferrous oxide, has a Fe content of between 25 and 70% and an inert material content (ganga) that is very variable. Magnetite is magnetic and therefore easily separable in mining processes, but since it is not easy to reduce even if at high temperatures, it is preferentially oxidized into hematite for improving its possibilities of use. Other minerals are Siderite (FeCO₃) which requires, before being used, a calcination step for eliminating some CO₂ and Limonite (FeO(OH)·nH₂O) which has a very low Iron content and which requires a dehydration treatment before of its utilization.

For what it concerns the synthesis gas, this is industrially produced with the technologies of: i) Steam Reforming (“SR”), ii) non-catalytic Partial Oxidation (“Pox”), iii) AutoThermal Reforming (“ATR”). A relatively recent variant of the SR technology is also the Gas Heated Reforming (“GHR”) technology, which, at least partially, replaces the radiant heat required for endothermic catalytic reactions with a convective source, typically consisting of i) hot gas produced by combustion reactions; and/or ii) by the synthesis gas produced by an ATR or by a POx. When SR and GHR technologies are integrated with ATR or POx technologies, the obtained process is referred to as Combined Reforming (“CR”) process.

Table 1 shows the main reactions involved in the synthesis gas production processes, while the characteristics of the above-mentioned technologies are described in numerous literature documents, among which the following ones are mentioned:
“Technologies for large-scale gas conversion” Aasberg-Petersen, K., Bak Hansen, J.-H., Christensen, T. S., Dybkjaer, I., Christensen, P. Seier, Stub Nielsen, C., Winter Madsen, S.
E. L., Rostrup-Nielsen, J. R., Applied Catalysis A: General, 221 (1-2), p.379, November 2001;
“Synthesis Gas production by Steam Reforming”, Dybkjaer, Ib; Seier Christensen P.; Lucassen Hansen V.; Rostrup-Nielsen J. R., EP1097105A1
J. R. Rostrup-Nielsen, J. Sehested and J. K. Noskov, Adv. Catal. 47 (2002), pp. 65-139;
“Catalytic Steam Reforming”; Rostrup-Nielsen J. R.; pg 1-117, Catalysis Vol. 5, Edited by John R. Anderson and Michel Boudart,

TABLE 1

| | ΔH°_{298 K} | |
|---|---|---|
| Steam - CO₂ Reforming | | |
| CH₄ + H₂O = CO + 3 H₂ | 206 | [5] |
| CO + H₂O = CO₂ + H₂ | −41 | [6] |
| CH₄ + CO₂ = 2CO + 2 H₂ | 247 | [7] |
| Non-Catalytic Partial Oxidation (POx) | | |
| CH₄ + 3/2 O₂ = CO + 2 H₂O | −520 | [8] |
| CO + H₂O = CO₂ + H₂ | −41 | [9] |
| Autothermal Reforming (ATR) | | |
| CH₄ + 3/2 O₂ = CO + 2 H₂O | −520 | [10] |
| CH₄ + H₂O = CO + 3 H₂ | 206 | [11] |
| CO + H₂O = CO₂ + H₂ | −41 | [9] |
| Catalytic Partial Oxidation (CPO) | | |
| CH₄ + 1/2 O₂ = CO + H₂ | −38 | [12] |
| CO + H₂O = CO₂ + H₂ | −41 | [13] |

Synthesis gas is used in many chemical transformations for obtaining: i) ammonia and urea, ii) methanol and its derivatives, iii) liquid hydrocarbons with the Fischer-Tropsch process, iv) acetic acid synthesis, v) hydroformylation reactions for producing several chemical substances. The H₂ produced from the synthesis gas through the water gas shift reaction [6] has also other numerous uses, in refining processes, in petrochemical and fine chemistry, in the electronics, metal refining and food industries.

It is also noted that the industrial processes that use the synthesis gas require that it is produced with quite different compositions in terms of H₂ vs. CO ratios, steam, CO₂ and CH₄ residue contents.

While the use of synthesis gas in the mentioned processes is widespread, its use in the reduction of iron ore is still limited to the DR reactors.

More in detail, it has been found that the DR process requires a synthesis gas with the following main features:
1) Low steam content (possibly lower than 8% v/v)
2) Low methane residues (possibly lower than 5% v/v in the dry synthesis gas)
3) R ratios possibly higher than 7 v/v

wherein R═(CO+H₂)/(CO₂+H₂O)v/v [14]
4) High syngas temperatures at the DR inlet (possibly higher than 850° C.)
5) Low pressure (typically lower than 5 kg/cm²)

Clearly these features would also need to be achieved with technologies emitting low amount of greenhouse gases (GHG) and by consuming low amounts of energy.

Noteworthy, the steam —CO₂ reforming, and ATR technologies have limitations for achieving these features

The steam —CO₂ reforming furnaces are strong emitters of CO₂ that is contained in a low-pressure gas in the presence of an excess of air. From this gaseous mixture the recovery of CO₂ is expensive and inefficient. This means that steam —CO₂ reforming is a strong GHG emitter. Moreover, the steam —CO₂ reforming process produces a syngas with a R value that not always can reach high values and with a non-optimal steam residue; this happens because the CO₂ contained in the DRG, if recycled, cannot be sufficiently transformed into H₂ and CO.

The ATR can instead produce a synthesis gas with a high R ratio and a low steam content but this can occur only at high pressure (typically greater than 20 kg/cm²); at low pressure (as already mentioned DR processes typically operate between 2 and 5 kg/cm²) this technology produces, in the combustion chamber, some unsaturated molecules and carbon residues which deactivate the catalysts located downstream from the combustion chamber. For this reason, ATR has strong limitations for producing the synthesis gas suitable for Iron ores reduction processes. In addition, the ATR reactor also requires high pre-heating temperatures (ca 550° C.) of the gaseous currents, in particular of the hydrocarbon reactants and therefore also this technology requires the use of preheating furnaces that again are strong emitters of CO₂ that cannot be efficiently recovered as it occurs in the case of steam —CO₂ reforming technology. In conclusion, it is also reported that the Non-Catalytic Partial Oxidation (POx) process is less efficient than catalytic processes and requires higher oxygen and hydrocarbon feedstock consumption. The POx use is advantageous only if one wants to use a hydrocarbon charge consisting of heavy residues produced by oil or coal processing, and although it can produce high temperature syngas, this is produced with a high CO₂ content, a low R value and includes the formation of carbonaceous residues.

The plus and minus of the above-mentioned technologies have led to the choice of steam —CO₂ reforming technology as the current best solution for integrating the production of syngas and its use in DR.

However, in addition to the limitations mentioned above, a further limitation of the steam —CO₂ reforming process concerns its low flexibility for following the variation of the DR reactor production cycles. In these transient contexts it is necessary an additional purge of the Direct Reduction Gas (DRG) that clearly results in a reduction of the energy efficiency of the process and in an increase of GHG emissions.

In conclusion, it is noted that, although the integration of the steam —CO₂ reforming and the DR followed by EAF results in a solution that improves the energy efficiency and reduces the environmental impact with respect to the BF+BOF solution, it remains energy and capital intensive with sustainability characteristics that still demand for improvements.

### SUMMARY OF THE INVENTION

It has now been found that the use of synthesis gas produced by means of a Short Contact Time —Catalytic Partial Oxidation (CPO) in the process of direct reduction (DR) of iron ores allows to eliminate or minimize the disadvantages of the conventional direct reduction processes, which use synthesis gas produced with other technologies, including the steam —CO₂ reforming.

### DESCRIPTION OF THE FIGURES

The invention will be described also with reference to the attached figures, in which:

FIG. 1, as already mentioned, is a simplified block diagram of a conventional process for direct reduction of iron ores;

FIGS. 2-5 are simplified block diagrams of embodiments of the process for direct reduction of iron ores according to the invention, which use syngas produced by Short Contact Time-Catalytic Partial Oxidation (CPO).

### DETAILED DESCRIPTION OF THE INVENTION

The Short Contact Time-Catalytic Partial Oxidation (“CPO”) process to produce syngas can be advantageously utilized and integrated with the DR process for improving its energy efficiency and reducing the GHG emissions.

The CPO technology is described in several documents, including:
WO2020058859 (A1), WO2016016257 (A1), WO2016016256 (A1), WO2016016253 (A1), WO2016016251 (A1), WO2011151082, WO2009065559, WO2011072877, US 20,091,27512, WO2007045457, WO2006034868, US2005211604, WO2005023710, WO 9737929, EP 0725038, EP 0640559,
“Issues in H₂ and synthesis gas technologies for refinery, GTL and small and distributed industrial needs”; Basini, Luca, Catalysis Today, 106 (1-4), p.34, October 2005,
“Fuel rich catalytic combustion: Principles and technological developments in short contact time (SCT) catalytic processes”; Basini, L.; Catalysis Today, 117 (4), 384-393; DOI: 10.1016/j.cattod.2006.06.043 Published: Oct. 15 2006
“Natural Gas Catalytic Partial Oxidation: A Way to Syngas and Bulk Chemicals Production | IntechOpen”; G. Iaquaniello, E. Antonetti, B. Cucchiella, E. Palo, A. Salladini, A. Guarinoni, A. Lainati and L. Basini; http://dx.doi.org/10.5772/48708
“Short Contact Time Catalytic Partial Oxidation (CPO) for Synthesis Gas Processes and Olefins Production”; L. E. Basini, A. Guarinoni, Ind. Eng. Chem. Res. 2013, 52, 17023-17037; https://doi.org/10.1021/ie402463m

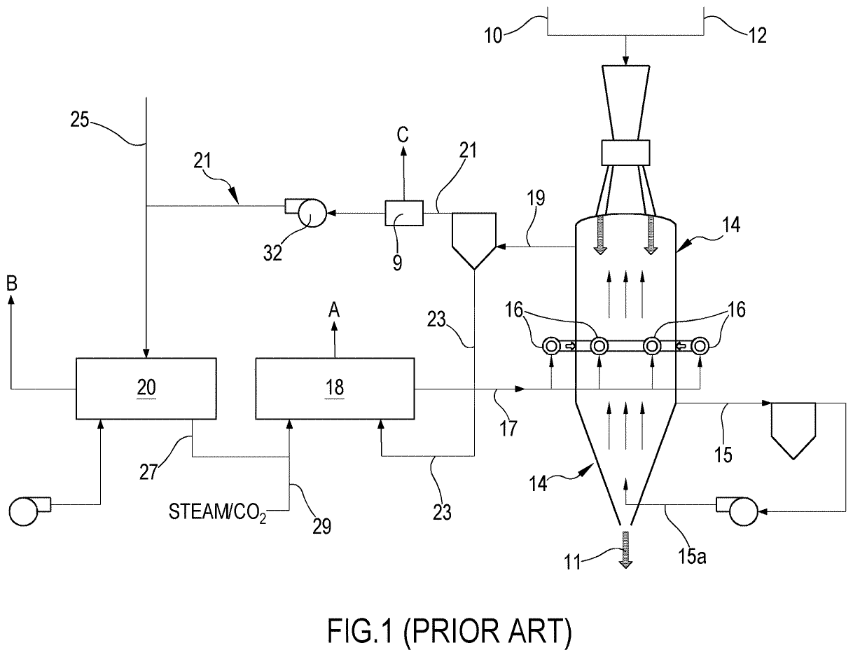

The integration and use of CPO in the DR process is an aspect of the present invention. Noteworthy we have found that the characteristics of the CPO technology allow the following advantages:
1. Quick response to changes in the production cycle, including changes in DR reactor pressure, and DRG flow. This avoids or greatly reduces the purge of syngas (point (C) of FIG. 1) required by the integration of the Steam —CO₂ reforming with DR, thus drastically reducing Natural Gas (“NG”) consumption and GHG emissions.
2. Avoidance of the steam —CO₂ reforming pre-heating and heating furnaces with a further relevant reduction in Green House Gases (“GHG”) emissions, in particular of CO₂ emitted at points (A) and (B) of FIG. 1.
3. Confinement of all the CO₂ molecules in the synthesis gas flow that is fed to the unit of DR. This avoids CO₂ emissions and allow the partial conversion of this molecule through the reverse water gas shift reaction (“RWGS”) into CO.
4. Obtainment of a synthesis gas at relatively low pressures (typically between 2 and 15 kg/cm² and preferentially between 2 and 10 kg/cm²) at high temperature (typically higher than 750° C. and preferentially higher than 850° C.) with a high R ratio (typically higher than 5 v/v and preferentially higher than 7.5 v/v) and a low steam content (typically lower than 10% v/v and preferentially higher than 5% v/v).

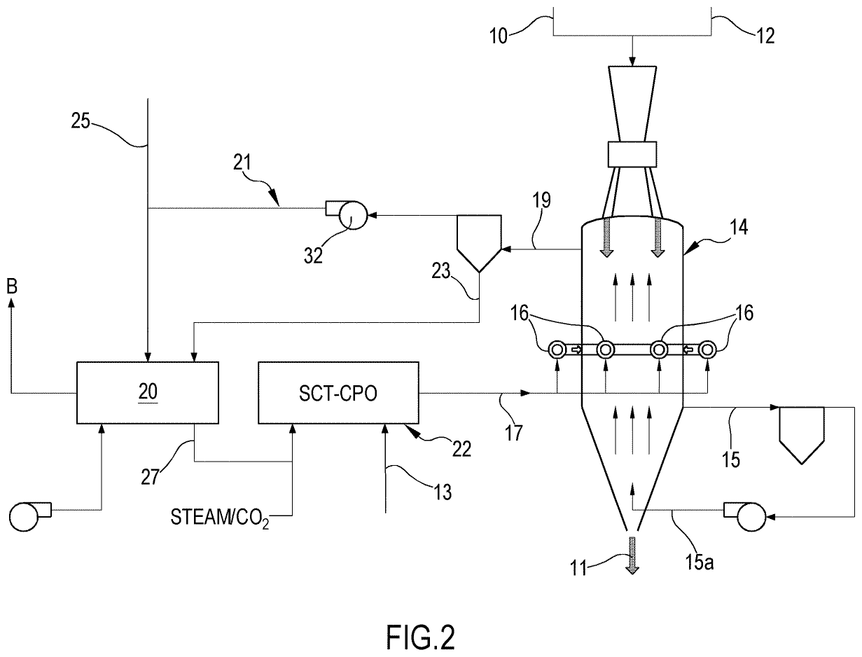

FIG. 2 shows a simplified block diagram of an embodiment of the process that integrates CPO and DR technologies.

With reference to FIG. 2, fine high grade iron ores 10, typically with an iron content of 66% by weight, and lump ores 12, typically with a size of 7-25 mm, are fed from the top of a shaft furnace 14. Synthesis gas is introduced through tuyeries 16 at the top half of the furnace. The syngas reacts in a countercurrent flow with the iron ores and direct-reduces them to sponge iron 11, which is cooled in the bottom half of the shaft before being discharged. Cooling is achieved by withdrawing hot gases from the bottom half of the shaft furnace 14, passing them through a cooling circuit 15 and re-introducing them at the bottom of the shaft via a line 15a.

The syngas is produced in a CPO reactor 22 and fed to the tuyeries 16 via a line 17. In this case, all the Direct Reduction Gas (DRG) withdrawn from the top of shaft 14 via a line 19 is conveyed to the feedstock pre-heater 20 via lines 19, 21 and compressor 32. A part of the DRG is fed via line 23 to the feedstock pre-heater 20 and used as fuel. The feedstock is then recycled to the CPO reactor via line 27 and mixed with steam and CO₂ fed from a line 29.

Natural gas is fed through line 25 to the feedstock pre-heater 20, from which it is conveyed to the CPO reactor 22 via a line 27.

According to the invention, all the Direct Reduction Gas (DRG) is recycled at the CPO reactor, so that the Green House Gases (GHG) emission points (A) and (C) related to the use of Steam-CO₂ reforming technology are no longer present. With respect to the three major emission points of GHG shown in FIG. 1 for a conventional DR process, only point B associated with the flue gas of the feedstock pre-heating furnace 20 is present.

Noteworthy pure O₂, enriched Air or Air can be used for producing synthesis gas with SCT-CPO, and are fed through line 13.

The pure O₂ and enriched Air streams can be obtained either with a cryogenic Air Separation Unit (ASU) or a Vacuum Pressure Swing Adsorption (VPSA) unit.

However, it is noted that also steam/water electrolysis and CO₂ electrolysis can produce O₂ streams that can be added to Air for obtaining enriched Air production or that can be used as such.

Moreover, steam/water electrolysis also produces H₂ while CO₂ electrolysis also produces CO and indeed these molecules are the main currently utilized products of electrolysis. Accordingly, while the O₂ is used by the CPO process, the co-produced H₂ and/or CO can be mixed to the reactants and sent to the CPO reactor or added to the produced syngas stream before of the DR reactor.

These embodiments also allow a further increase of the R values.

The electrolytic technologies hence produce molecules that can be all integrated in the innovative process according to the invention. The electrolysis processes that can be utilized in the process applications here described are:
i) Alkaline Electrolysis (AE)
ii) Polymer Electrolyte Membrane (“PEM”) electrolysis,
iii) Solid Oxide Electrolysis Cells (“SOEC”) that can be utilized also for CO₂ electrolysis or mixed steam and CO₂ electrolysis.

Noteworthy, the autothermal nature of the CPO process allows the addition of H₂ and CO produced by the electrolytic processes to the reactant mixture to be fed to the CPO reactor, thus avoiding preheating systems utilizing CO₂ emitting furnaces and nevertheless obtaining high-temperature synthesis gas production useful for DR

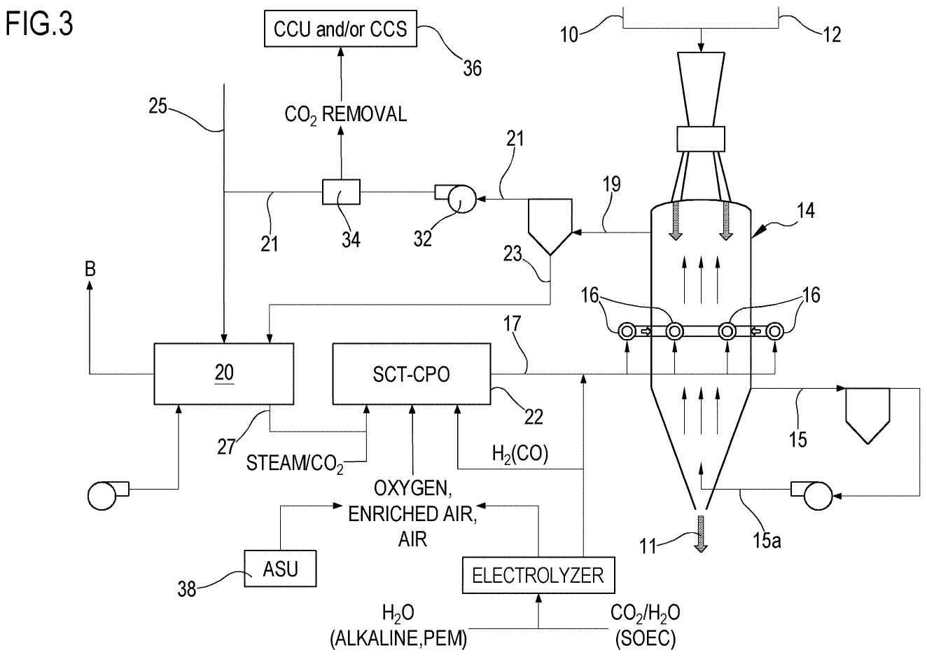

This embodiment is shown in FIG. 3, which is a simplified block scheme of an Iron Ores Direct Reduction process utilizing short contact time CPO for the production of synthesis gas. The process uses also an electrolysis to produce Oxygen, Hydrogen, and Carbon Monoxide that are used for the short contact time CPO reactions and for increasing the hydrogen content in the produced synthesis gas.

With reference to FIG. 3, the Direct Reduction shaft furnace 14, the CPO reactor 22 and the feedstock pre-heater 20 are the same as in FIG. 2. Same are also the cooling circuit 15 of the gas in the bottom half of the shaft furnace 14, and the recycle of the Direct Reduction Gas (“DRG”) to the feedstock pre-heater and from this to the CPO reactor. Reference is made to the description of FIG. 2 for the parts with the same numbers.

In this embodiment, use is made of an electrolyzer plant 30 for the production of Oxygen, Hydrogen and Carbon Monoxide that are fed to the short contact time CPO reactor via line 31, and for increasing the hydrogen content in the produced synthesis gas. The electrolyzer 30 can perform a PEM electrolysis or a SOEC electrolysis.

The process scheme also includes a CO₂ removal unit 34 that allows the operation 36 of Carbon Capture and Utilization (“CCU”) and/or Carbon Capture and Storage (“CCS”).

The pure O₂ and enriched Air streams can be obtained also with a cryogenic Air Separation Unit (“ASU”) 38.

It is also mentioned that the technological development of the iron and steel industry is moving towards solutions that use H₂ as a reducing gas, preferentially produced with electrolytic processes utilizing renewable electric energy sources.

However, these solutions have limitations mainly related to the endothermicity of the reactions of reduction of the iron oxides performed with H₂. Hence, the use of only H₂ leads to endothermic reduction reactions of ferrous minerals which are slower than the reductions performed with CO, and which require increasing both the temperatures of the synthesis gas mixtures and the size of the reactors.

In this context, the innovative integration described here allows the: i) modulation of the H₂ and CO content in the produced syngas to be sent in the DR process, ii) avoidance of pre-heating and heating furnaces, iii) inclusion of the H₂ and/or CO produced from electrolysis to the CPO reactor together with the reactant mixture, iv) increase of the percentage of electrification in the iron ore reduction process, v) increase of the R value.

The CPO process also allows the production of a synthesis gas suitable for the reduction processes in DR reactors using different hydrocarbon sources such as:
i) Natural Gas also containing large amounts of CO₂ (often called acid NG);
ii) Direct Reduction Gas;
iii) purge gases and the off gases produced in the refining, chemical and petrochemical processes;
iv) biogases with a biomass origin;
v) blast furnace gas (BFG) and the Coke Oven Gas (COG) produced in the Iron Ores reduction process utilizing the Blast Furnace (see their typical compositions in Tables 2 and 3. More specifically, it is noted that COG and/or BFG are produced in steel making processes utilizing the Blast Furnace.

However, as already mentioned, these widespread industrial solutions have relevant sustainability problems (Best Available Techniques (BAT) Reference Document: for: Iron and Steel Production: Industrial Emissions Directive 2010/75/EU: (Integrated Pollution Prevention and Control)| EU Science Hub (europa.eu)_related to pollutant emissions either as particulate matter and as gaseous compounds.

The pollutant emission is mainly originated by the coking production furnaces. Here coal is heated at high temperature and transformed in coke and this process also releases particulate matter and COG with additional minor component amounts, not included in Table 2, (from P. Burmistrz, L. Czepirski and M. Gazda-Grzywacz; “Carbon dioxide emission”, E3S Web of Conference 10, 0023 2016. DOI: 10.1051/e3sconf/20161000023) consisting of 02, H₂S, HCN, SO₂ and polyaromatic compounds. Moreover, in addition to COG, which is currently used to produce thermal and/or electrical energy, the BF produces significant quantities of BFG whose typical composition is included in Table 3 (from P. Grammelis, N. Margaritis, E. Karampinis; “Solid fuel types for energy generation: Coal and fossil carbon-derivative solid fuels”; Solid, Liquid and Gaseous Fuels 2016, Pages 29-58. https://doi.org/10.1016/B978-1-78242-378-2.00002-X) that again is used to produce thermal and/or electrical energy.

We have now surprisingly found that, according to an aspect of the invention, the Direct Reduction process of iron ores can be carried out by means of syngas produced by the CPO technology which also utilizes COG and/or BFG as feedstock for the CPO reactor. This opportunity can be exploited for integrating DR and BF processes.

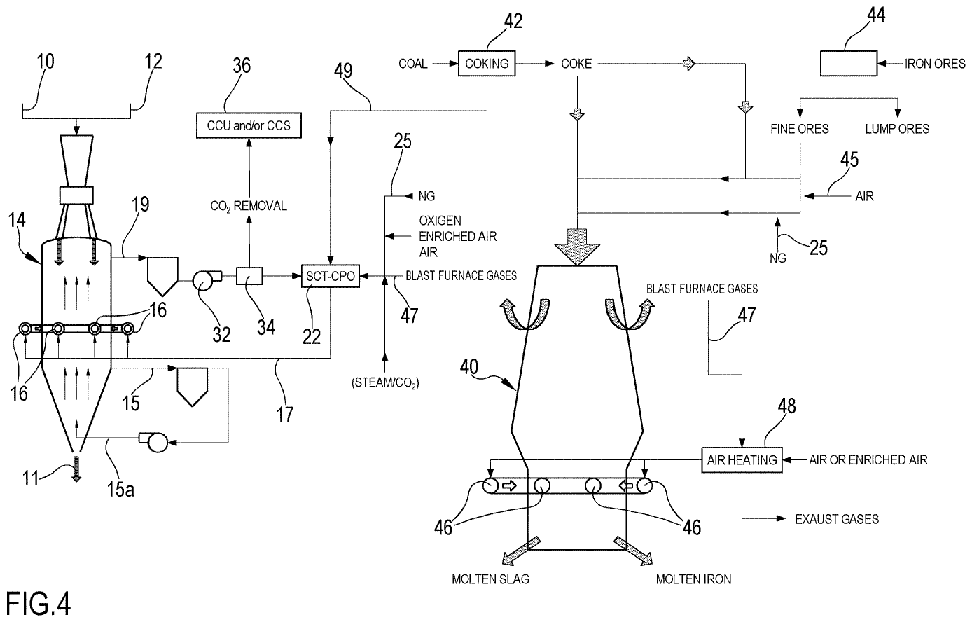

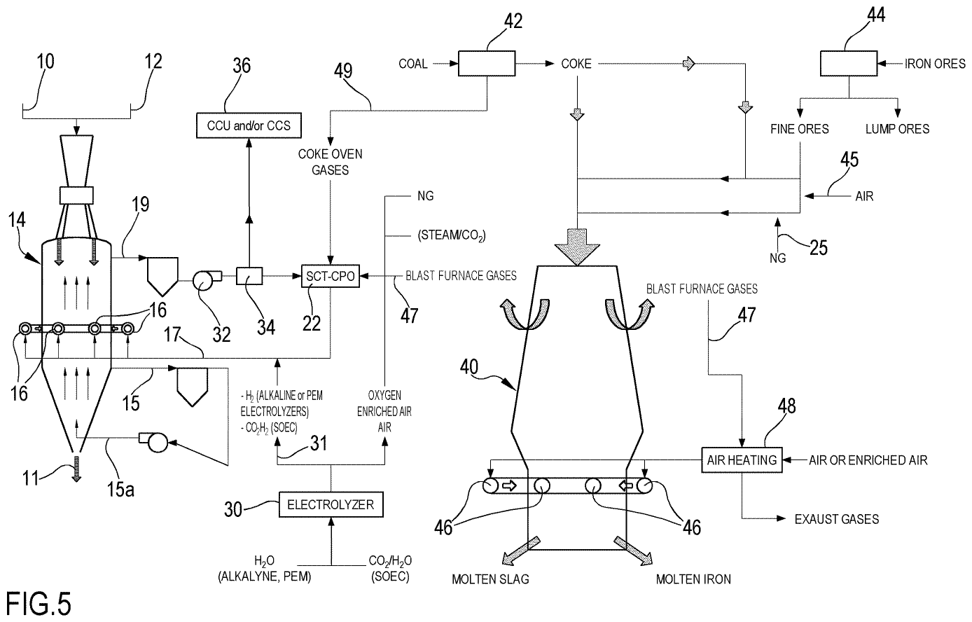

FIGS. 4 and 5 outline embodiments of these integrated DR and BF processes.

The process according to the invention therefore also comprises the use of COG and BFG in the production of synthesis gas used by the DR process.

Table 2 shows a typical composition of the Coke Oven Gas and FIG. 3 shows a typical composition of Blas Furnace Gas.

TABLE 2

| COG | v/v % |
|---|---|
| H₂ | 41.7 |
| CO | 2.3 |
| CH₄ | 19.7 |
| CO₂ | 1.0 |
| C₂H₆ | 2.6 |
| H₂S | 0.6 |
| NH₃ | 1.9 |
| H₂O | 28.0 |
| Benzol | 0.8 |
| Tar | 1.5 |

TABLE 3

| BFG | v/v |
|---|---|
| CH₄ | 0.00% |
| CO | 20.78% |
| CO₂ | 21.27% |
| H₂ | 2.76% |
| H₂O | 2.76% |
| N₂ | 55.19% |

With reference to FIG. 4, a simplified block scheme of an Iron Ores Direct Reduction process integrated with a BF reduction process is shown, according to an embodiment of the invention. This DR process utilizes short contact time CPO for the production of synthesis gas, and includes in the reactant mixture COG and BFG produced with the BF Iron Reduction cycle in the feedstock mixture fed to the CPO reactor. Reference is made to the description of FIG. 3 for the parts that have the same numbers, which is the section concerning the shaft furnace 14 and the SCT-CPO reactor. The process scheme also includes a CO₂ removal unit 34 that allows the operation 36 of Carbon Capture and Utilization and/or Carbon Capture and Storage.

A Blast Furnace 40 is fed with coke produced in a coking oven 42, iron ore is crushed in a crusher 44, air is fed through a line 45 and part of the blast furnace gas is used through a line 47 for preheating the Air in 48. Hot air, or oxygen enriched hot air, is introduced in the bottom part of the BF through tuyeries 46.

Hot waste gases, or BFG, are withdrawn through line 47, partly used to pre-heat the air or the enriched air in a pre-heater 48, and partly fed to the CPO reactor via line 47, together with natural gas, oxygen and/or air. Furthermore, a Coke Oven Gas (COG) produced in the coke oven 42, is also fed to the CPO reactor 22 via line 49, to be converted into syngas. With reference to FIG. 5, a simplified block scheme of an Iron Ores Direct Reduction process integrated with BF reduction process is shown, according to another embodiment of the invention. This DR process utilizes short contact time CPO for the production of synthesis gas also including, in the reactant mixture fed to the CPO reactor, COG and BFG produced with the BF Iron Reduction cycle. The process also includes electrolyzer units for producing Oxygen used in the CPO reactor and Hydrogen that is added to the produced syngas. Reference is made to the description of FIG. 4 for the parts that have the same numbers, and to the description of FIG. 3 for the section of the scheme concerning the electrolyzer 30.

The integration of DR and BF processes, which is only possible with CPO technology, avoids the reduction of production and avoids the use of coke. The integrated process also avoids the surplus of thermal and electrical energy associated to the cast iron production with BF. The process according to the invention also allows relevant savings of natural gas and consequently the reduction of CO₂ emissions in an integrated processes including either DR and BF.

Since the DR typically operates at pressures between 2 and 5 kg/cm², the production of syngas will take place at slightly higher pressures and the syngas produced will be sent directly, without undergoing cooling and purification processes, to the DR furnace.

The CPO operating conditions useful for the embodiments described above can be summarized as follows:
i) feedstock preheating temperatures comprised between 10° and 550° C. and preferentially between 15° and 450° C.;
ii) inlet pressures comprised between 15 and 2 kg/cm² and preferentially between 10 and 3 kg/cm²;
iii) pressure drop values between 5 e 0.1 kg/cm² and preferentially between 0.5 and 3 kg/cm²;
iv) steam vs. carbon ratio (S/C) estimated only considering the carbon atoms of hydrocarbon compounds comprised between 0 and 1.5 v/v and preferentially between 0 and 0.5 v/v;
v) Oxygen vs carbon ratios (O₂/C) estimated considering only the moles of carbon atoms included in hydrocarbon reactants, comprised between 0.30 e 0.70 v/v and preferably between 0.50 and 0.65 v/v;
vi) Syngas temperatures above 750° C. and preferentially above 850° C.

For what it concerns the operation conditions and particularly the requirements of S/C values, it is noted that these can be lowered to zero with CPO since with this technology solution the presence of CO₂ inhibits the carbon formation reactions (see for instance Chemical Engineering Journal 165 (2010) 633-638). This is a unique CPO feature that cannot be produced with steam-CO₂ reforming reactions

More in detail, it is reported that the production of CO-rich syngas by steam —CO₂ reforming and/or dry reforming is affected by the possible deactivation of the catalysts due to the carbon formation reactions [15-18]:

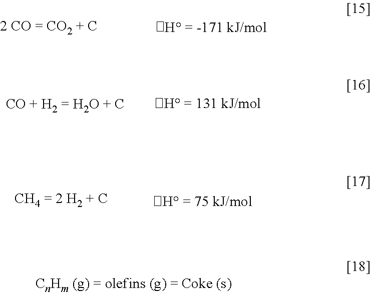

Reactions [15-18] are the primary sources of carbon in steam —CO₂ reforming that can be divided into three typologies: i) whisker carbon, ii) gum (encapsulating carbon), and iii) pyrolytic carbon.

Gum formation and pyrolytic carbon are especially associated with the presence of hydrocarbons with more than two carbon atoms in the feedstock and can be avoided by removing these molecules with a pre-reformer unit upstream dry reforming.

Instead, the production of whisker carbon can only be avoided by operating in condition having a low thermodynamic affinity towards this species that once formed bring to the catalyst pellet destruction and to the plant shut down due to the necessity of avoiding that the heat flow from the furnace not adsorbed by the endothermic reactions could lead to tubes overheating and fracturing.

Therefore, one of the primary tasks in the development of a steam —CO₂ reforming and/or dry reforming processes, is the careful theoretical and experimental analysis of the allowed carbon free operating conditions.

Significant research has been conducted for limiting, with appropriate catalysts definition, the carbon formation reactions. However, whisker carbon formation remains primarily dictated by thermodynamics instead of kinetics and its avoidance can be obtained only in limited operation conditions.

Nickel, cobalt, and noble metal catalysts, among others, have been extensively studied as potential catalysts for steam —CO₂ reforming and dry reforming, with nickel being the most investigated system, as this is, cost-wise, the most attractive catalyst.

Nobel metal catalysts are also utilized since they typically have a lower kinetic affinity for carbon formation and a higher activity for steam and CO₂ reforming reactions.

In addition, it is noted that the CO₂ consumption features in steam —CO₂ and dry reforming is limited by the emissions determined by the heating furnaces. Indeed, the CO₂ reforming reaction [7] requires ca. 22% of enthalpy more than steam reforming [5] and this heat is currently provided in heating furnaces with reactions such as [19]:

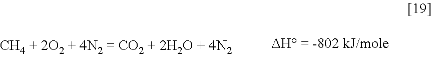

Since the heat transferred into the reaction inside the reforming tubes is roughly the 50% of the heat released by the combustion reactions [19], it can be estimated that per any CO₂ molecule consumed with reaction [7] ca 0.6 CO₂ molecules would be produced when the reaction heat is provided by burning CH₄ molecules.

The Iron Ores Direct Reduction process utilizing short contact time CPO for the production of synthesis gas overcomes the steam —CO₂ reforming and the dry reforming drawbacks related to the occurrence of carbon formation reactions by utilizing CPO reactors with a catalytic bed having a truncated cone geometry placed between thermal shields.

This reactor configuration, an appropriate choice of the catalyst composition and shape and an appropriate selection of operation conditions does not determine the occurrence of the carbon formation reactions at the catalyst surfaces also in the presence of large amounts of CO₂ in the reactant mixture. Indeed, it has also been found that with the utilization of the CPO reactor solutions here described, the presence of the CO₂ inside the reactant molecules mixture, inhibits not only the occurrence of carbon formation reactions onto the catalysts surfaces but also inhibits the occurrence of radical reactions in the gas phase that, particularly at high pressure conditions, lead to unsaturated hydrocarbon formation that can further aggregate and decompose, thus producing carbonaceous deposits.

Hence, in the CPO systems here described the carbon formation reactions observed in Steam-CO₂ reforming and dry reforming cannot be originated.

It is stressed the point that only with the adopted and here described process, we have found that: i) the presence of CO₂ in the reactant mixture inhibits the propagation of the unselective radical reactions inside the reactant/product gaseous mixture progressing inside the CPO reactor while ii) the CO₂ participates the heterogeneous chemistry inside the catalytic bed after that relevant amounts of hydrocarbons have been already transformed into synthesis gas.

Furthermore, the process of the invention avoids the use of massive CO₂ emitting preheating furnaces, allow the removal of CO₂ from process gases making it available for Carbon Capture and Storage (CCS) processes and Carbon Capture and Utilization (CCU) as shown in FIGS. 3, 4 and 5.

The composition of the reagent mixtures and the operating conditions of the CPO reactors shall be combined to produce a synthesis gas with a high reducing potential suitable to the reduction reactions of the ferrous minerals and in particular a synthesis gas with:
a steam fraction of less than 10% v/v and preferably less than 5% v/v a ratio R═(H₂+CO)/(H₂O+CO₂) Exceeding 5 v/v and preferably exceeding 7.5 v/v. As already mentioned, in some contexts, the Direct Reduced Iron, in the form of Hot Briquette Iron, is also introduced in the charge of a Blast Furnace together with ferrous minerals and coke to increase the iron content of the molten metal and to allow an optimization of the energy efficiency of the complete cycles of reduction of iron ores and steel production by BOF or EAF. The use of SCT-CPO technology therefore provides an additional advantage resulting both in the combined use of Direct Reduction Gas, Coke Oven Gas, Blast Furnace Gas and partial use of Hot Briquette Iron in Blast Furnace+Blast Oxygen Furnace/Electric Arc Furnace with additional energy benefits.

The invention will now be described with reference to the following non-limitative examples.

### Examples

### Example 1: Syngas Production from Natural Gas, Oxygen (O₂/C=0.7), Steam (S/C=0.17) and Recycled Gas from a Direct Reduction Furnace

Natural Gas was fed to the CPO reactor with recycled DRG in a process as shown in FIG. 2. Water and CO₂ were removed from the DRG before being mixed to the hydrocarbon stream. The Hydrocarbon mixture was then preheated at 400° C. before entering the CPO reactor. Syngas was produced at 3 bar and 980° C. with a value of R═11 v/v.

TABLE 4

| | | | | | | CPO- | CPO- |
|---|---|---|---|---|---|---|---|
| | Units | NG | DRG | Steam | O2 | in | out |
| Temperature | ° C. | 25 | 300 | 220 | 25 | 400 | 980 |
| Pressure | bar | 5 | 1.5 | 5 | 5 | 5 | 3 |
| Average | | 16.9 | 15.9 | 18.0 | 32.0 | 12.8 | 10.5 |
| MW | | | | | | | |
| Mole | kmol/ton_DRI | 8.1 | 71.6 | 1.7 | 6.9 | 58.5 | 71.0 |
| Flows | | | | | | | |
| Mole | | | | | | | |
| Fractions | | | | | | | |
| CH4 | | 0.95 | 0.02 | 0.00 | 0.00 | 0.16 | 0.00 |
| C2H6 | | 0.02 | 0.00 | 0.00 | 0.00 | 0.00 | 0.00 |
| C3H8 | | 0.01 | 0.00 | 0.00 | 0.00 | 0.00 | 0.00 |
| O2 | | 0.00 | 0.00 | 0.00 | 1.00 | 0.12 | 0.00 |
| CO2 | | 0.00 | 0.13 | 0.00 | 0.00 | 0.00 | 0.02 |
| H2O | | 0.00 | 0.29 | 1.00 | 0.00 | 0.03 | 0.07 |
| HE | | 0.00 | 0.00 | 0.00 | 0.00 | 0.00 | 0.00 |
| H2 | | 0.00 | 0.43 | 0.00 | 0.00 | 0.52 | 0.66 |
| CO | | 0.00 | 0.12 | 0.00 | 0.00 | 0.14 | 0.24 |
| N2 | | 0.02 | 0.02 | 0.00 | 0.00 | 0.03 | 0.02 |

Use of this syngas in the DR furnace was effective in reducing the iron ore to Direct Reduced Iron. The amount of syngas (CPO-out) reported in Table 4 was suitable to produce 1 ton of Direct Reduced Iron in the DR furnace.

### Example 2: Syngas Production from Natural Gas, Oxygen (O₂/C=0.71), Steam (S/C=0.05) and Recycled Gas from the DR Furnace. CO₂ Contained in the DRG is Partially Recycled in the CPO Reactor (CO₂/C=0.18)

Natural Gas was fed to the CPO reactor with recycled DRG in a process as shown in FIG. 2. Water and part of the CO₂ were removed from the DRG before being mixed to the hydrocarbon stream. The Hydrocarbon mixture was then preheated at 400° C. before entering the CPO reactor. Syngas was produced at 3 bar and 980° C. with a value of R═9.73 v/v.

TABLE 5

| | | | | | | CPO- | CPO- |
|---|---|---|---|---|---|---|---|
| | Units | NG | DRG | Steam | O2 | in | out |
| Temperature | ° C. | 25 | 300 | 220 | 25 | 400 | 980 |
| Pressure | bar | 5 | 1.5 | 5 | 5 | 5 | 3 |
| Average | | 16.9 | 16.8 | 18.0 | 32.0 | 14.5 | 11.9 |
| MW | | | | | | | |
| Mole | kmol/ton_DRI | 9.4 | 78.5 | 0.6 | 7.7 | 63.5 | 77.2 |
| Flows | | | | | | | |
| Mole | | | | | | | |
| Fractions | | | | | | | |
| CH4 | | 0.95 | 0.02 | 0.00 | 0.00 | 0.16 | 0.00 |
| C2H6 | | 0.02 | 0.00 | 0.00 | 0.00 | 0.00 | 0.00 |
| C3H8 | | 0.01 | 0.00 | 0.00 | 0.00 | 0.00 | 0.00 |
| O2 | | 0.00 | 0.00 | 0.00 | 1.00 | 0.12 | 0.00 |
| CO2 | | 0.00 | 0.15 | 0.00 | 0.00 | 0.03 | 0.02 |
| H2O | | 0.00 | 0.25 | 1.00 | 0.00 | 0.01 | 0.07 |
| HE | | 0.00 | 0.00 | 0.00 | 0.00 | 0.00 | 0.00 |
| H2 | | 0.00 | 0.42 | 0.00 | 0.00 | 0.48 | 0.60 |
| CO | | 0.00 | 0.16 | 0.00 | 0.00 | 0.19 | 0.30 |
| N2 | | 0.02 | 0.01 | 0.00 | 0.00 | 0.01 | 0.01 |

Use of this syngas in the DR furnace was effective in reducing the iron ore to Direct Reduced Iron. The amount of syngas (CPO-out) reported in Table 5 was suitable to produce 1 ton of Direct Reduced Iron in the DR furnace.

### Example 3: Syngas Production from Natural Gas, Oxygen (O₂/C=0.72), Steam (S/C=0.05), Recycled Gas from the DR Furnace and Biogas (CO₂/C=0.18

Natural Gas was fed to the CPO reactor with recycled DRG and Biogas in a process as shown in FIG. 2. Water and CO₂ were removed from the DRG before being mixed to the hydrocarbon stream. The Hydrocarbon mixture was then preheated at 400° C. before entering the CPO reactor. Syngas was produced at 3 bar and 980° C. with a value of R═9.71 v/v.

TABLE 6

| | | | | | | | CPO- | CPO- |
|---|---|---|---|---|---|---|---|---|
| | Units | NG | BIOGAS | DRG | Steam | O2 | in | out |
| Temperature | ° C. | 25 | 25 | 300 | 220 | 25 | 400 | 980 |
| Pressure | bar | 5 | 5 | 1.5 | 5 | 5 | 5 | 3 |
| Average | | 16.9 | 28.6 | 17.0 | 18.0 | 32.0 | 14.8 | 12.2 |
| MW | | | | | | | | |
| Mole | kmol/ton_{—} | 7.1 | 4.2 | 79.3 | 0.5 | 7.7 | 64.9 | 78.5 |
| Flows | DRI | | | | | | | |
| Mole | | | | | | | | |
| Fractions | | | | | | | | |
| CH4 | | 0.95 | 0.55 | 0.02 | 0.00 | 0.00 | 0.16 | 0.00 |
| C2H6 | | 0.02 | 0.00 | 0.00 | 0.00 | 0.00 | 0.00 | 0.00 |
| C3H8 | | 0.01 | 0.00 | 0.00 | 0.00 | 0.00 | 0.00 | 0.00 |
| O2 | | 0.00 | 0.00 | 0.00 | 0.00 | 1.00 | 0.12 | 0.00 |
| CO2 | | 0.00 | 0.45 | 0.15 | 0.00 | 0.00 | 0.03 | 0.02 |
| H2O | | 0.00 | 0.00 | 0.24 | 1.00 | 0.00 | 0.01 | 0.07 |
| HE | | 0.00 | 0.00 | 0.00 | 0.00 | 0.00 | 0.00 | 0.00 |
| H2 | | 0.00 | 0.00 | 0.41 | 0.00 | 0.00 | 0.47 | 0.59 |
| CO | | 0.00 | 0.00 | 0.17 | 0.00 | 0.00 | 0.20 | 0.30 |
| N2 | | 0.02 | 0.00 | 0.01 | 0.00 | 0.00 | 0.01 | 0.01 |

Use of this syngas in the DR furnace was effective in reducing the iron ore to Direct Reduced Iron. The amount of syngas (CPO-out) reported in Table 6 was suitable to produce 1 ton of Direct Reduced Iron in the DR furnace.

### Example 4: Syngas Production from Natural Gas, Oxygen (O₂/C=0.72), Steam (S/C=0.04), Recycled Gas from the DR Furnace and Biogas (CO₂/C=0.20)

Natural Gas was fed to the CPO reactor with recycled DRG and Biogas in a process as shown in FIG. 2. Water and part of the CO₂ were removed from the DRG before being mixed to the hydrocarbon stream. The Hydrocarbon mixture was then preheated at 400° C. before entering the CPO reactor. Syngas was produced at 3 bar and 980° C. with a value of R═9.54 v/v.

TABLE 7

| | | | | | | | CPO- | CPO- |
|---|---|---|---|---|---|---|---|---|
| | Units | NG | BIOGAS | DRG | Steam | O2 | in | out |
| Temperature | ° C. | 25 | 25 | 300 | 220 | 25 | 400 | 980 |
| Pressure | bar | 5 | 5 | 1.5 | 5 | 5 | 5 | 3 |
| Average | | 16.9 | 28.6 | 17.2 | 18.0 | 32.0 | 15.0 | 12.5 |
| MW | | | | | | | | |
| Mole | kmol/ton_{—} | 9.0 | 0.8 | 80.6 | 0.5 | 7.8 | 66.3 | 79.8 |
| Flows | DRI | | | | | | | |
| Mole | | | | | | | | |
| Fractions | | | | | | | | |
| CH4 | | 0.95 | 0.55 | 0.01 | 0.00 | 0.00 | 0.15 | 0.00 |
| C2H6 | | 0.02 | 0.00 | 0.00 | 0.00 | 0.00 | 0.00 | 0.00 |
| C3H8 | | 0.01 | 0.00 | 0.00 | 0.00 | 0.00 | 0.00 | 0.00 |
| O2 | | 0.00 | 0.00 | 0.00 | 0.00 | 1.00 | 0.12 | 0.00 |
| CO2 | | 0.00 | 0.45 | 0.15 | 0.00 | 0.00 | 0.03 | 0.02 |
| H2O | | 0.00 | 0.00 | 0.24 | 1.00 | 0.00 | 0.01 | 0.07 |
| HE | | 0.00 | 0.00 | 0.00 | 0.00 | 0.00 | 0.00 | 0.00 |
| H2 | | 0.00 | 0.00 | 0.41 | 0.00 | 0.00 | 0.47 | 0.59 |
| CO | | 0.00 | 0.00 | 0.18 | 0.00 | 0.00 | 0.21 | 0.31 |
| N2 | | 0.02 | 0.00 | 0.01 | 0.00 | 0.00 | 0.01 | 0.01 |

Use of this syngas in the DR furnace was effective in reducing the iron ore to Direct Reduced Iron. The amount of syngas (CPO-out) reported in Table 7 was suitable to produce 1 ton of Direct Reduced Iron in the DR furnace.

### Example 5: Syngas Production from Natural Gas, Oxygen (O₂/C=0.77), Steam (S/C=0.16), Recycled Gas from the DR Furnace and BFG (CO₂/C=0.05)

Natural Gas was fed to the CPO reactor with recycled DRG and BFG in a process as shown in FIG. 4 but without using COG. Water and CO₂ were removed from the DRG before being mixed to the hydrocarbon stream. The Hydrocarbon mixture was then preheated at 400° C. before entering the CPO reactor. Syngas was produced at 3 bar and 980° C. with a value of R═9 v/v.

TABLE 8

| | | | | | | | CPO- | CPO- |
|---|---|---|---|---|---|---|---|---|
| | Units | NG | BFG | DRG | Steam | O2 | in | out |
| Temperature | ° C. | 25 | 25 | 300 | 220 | 25 | 400 | 980 |
| Pressure | bar | 5 | 5 | 1.5 | 5 | 5 | 5 | 3 |
| Average | | 16.9 | 29.4 | 17.7 | 18.0 | 32.0 | 16.1 | 13.9 |
| MW | | | | | | | | |
| Mole | kmol/ton_{—} | 9.7 | 2.7 | 97.1 | 1.5 | 8.3 | 82.2 | 95.3 |
| Flows | DRI | | | | | | | |
| Mole | | | | | | | | |
| Fractions | | | | | | | | |
| CH4 | | 0.95 | 0.00 | 0.01 | 0.00 | 0.00 | 0.12 | 0.00 |
| C2H6 | | 0.02 | 0.00 | 0.00 | 0.00 | 0.00 | 0.00 | 0.00 |
| C3H8 | | 0.01 | 0.00 | 0.00 | 0.00 | 0.00 | 0.00 | 0.00 |
| O2 | | 0.00 | 0.00 | 0.00 | 0.00 | 1.00 | 0.10 | 0.00 |
| CO2 | | 0.00 | 0.20 | 0.11 | 0.00 | 0.00 | 0.01 | 0.02 |
| H2O | | 0.00 | 0.08 | 0.21 | 1.00 | 0.00 | 0.02 | 0.07 |
| HE | | 0.00 | 0.00 | 0.00 | 0.00 | 0.00 | 0.00 | 0.00 |
| H2 | | 0.00 | 0.04 | 0.38 | 0.00 | 0.00 | 0.41 | 0.53 |
| CO | | 0.00 | 0.21 | 0.14 | 0.00 | 0.00 | 0.16 | 0.24 |
| N2 | | 0.02 | 0.47 | 0.14 | 0.00 | 0.00 | 0.17 | 0.15 |

Use of this syngas in the DR furnace was effective in reducing the iron ore to Direct Reduced Iron. The amount of syngas (CPO-out) reported in Table 8 was suitable to produce 1 ton of Direct Reduced Iron in the DR furnace.Example 6: Syngas production from Natural Gas, Oxygen (O₂/C=0.8), steam (S/C=0.07), recycled gas from the DR furnace and BFG (CO₂/C=0.29).

Natural Gas was fed to the CPO reactor with recycled DRG and BFG in a process as shown in FIG. 4 but without using COG. Water and part of the CO₂ were removed from the DRG before being mixed to the hydrocarbon stream. The Hydrocarbon mixture was then preheated at 400° C. before entering the CPO reactor. Syngas was produced at 3 bar and 980° C. with a value of R═8.05 v/v.

TABLE 9

| | | | | | | | CPO- | CPO- |
|---|---|---|---|---|---|---|---|---|
| | Units | NG | BFG | DRG | Steam | O2 | in | out |
| Temperature | ° C. | 25 | 25 | 300 | 220 | 25 | 400 | 980 |
| Pressure | bar | 5 | 5 | 1.5 | 5 | 5 | 5 | 3 |
| Average | | 16.9 | 29.4 | 17.8 | 18.0 | 32.0 | 16.2 | 14.2 |
| MW | | | | | | | | |
| Mole | kmol/ton_{—} | 9.8 | 2.9 | 103.7 | 0.5 | 8.7 | 88.8 | 101.6 |
| Flows | DRI | | | | | | | |
| Mole | | | | | | | | |
| Fractions | | | | | | | | |
| CH4 | | 0.95 | 0.00 | 0.01 | 0.00 | 0.00 | 0.11 | 0.00 |
| C2H6 | | 0.02 | 0.00 | 0.00 | 0.00 | 0.00 | 0.00 | 0.00 |
| C3H8 | | 0.01 | 0.00 | 0.00 | 0.00 | 0.00 | 0.00 | 0.00 |
| O2 | | 0.00 | 0.00 | 0.00 | 0.00 | 1.00 | 0.10 | 0.00 |
| CO2 | | 0.00 | 0.20 | 0.13 | 0.00 | 0.00 | 0.04 | 0.03 |
| H2O | | 0.00 | 0.08 | 0.20 | 1.00 | 0.00 | 0.01 | 0.07 |
| HE | | 0.00 | 0.00 | 0.00 | 0.00 | 0.00 | 0.00 | 0.00 |
| H2 | | 0.00 | 0.04 | 0.40 | 0.00 | 0.00 | 0.43 | 0.52 |
| CO | | 0.00 | 0.21 | 0.21 | 0.00 | 0.00 | 0.23 | 0.31 |
| N2 | | 0.02 | 0.47 | 0.06 | 0.00 | 0.00 | 0.07 | 0.06 |

Use of this syngas in the DR furnace was effective in reducing the iron ore to Direct Reduced Iron. The amount of syngas (CPO-out) reported in Table 9 was suitable to produce 1 ton of Direct Reduced Iron in the DR furnace.

### Example 7: Syngas Production from Natural Gas, Oxygen (O₂/C=0.82), Steam (S/C=0.15), Recycled Gas from the DR Furnace, BFG and COG (CO₂/C=0.04)

Natural Gas was fed to the CPO reactor with recycled DRG, BFG and COG in a process as shown in FIG. 4. Water and CO₂ were removed from the DRG before being mixed to the hydrocarbon stream. The Hydrocarbon mixture was then preheated at 400° C. before entering the CPO reactor. Syngas was produced at 3 bar and 980° C. with a value of R═8.99 v/v.

TABLE 10

| | | | | | | | | CPO- | CPO- |
|---|---|---|---|---|---|---|---|---|---|
| | Units | NG | BFG | COG | DRG | Steam | O2 | in | out |
| Temperature | ° C. | 25 | 25 | 70 | 300 | 220 | 25 | 400 | 980 |
| Pressure | bar | 5 | 5 | 5 | 1.5 | 5 | 5 | 5 | 3 |
| Average | | 16.9 | 29.4 | 10.8 | 17.7 | 18.0 | 32.0 | 15.6 | 13.8 |
| MW | | | | | | | | | |
| Mole | kmol/ton_{—} | 7.0 | 1.6 | 7.1 | 100.5 | 1.1 | 7.9 | 87.4 | 98.7 |
| Flows | DRI | | | | | | | | |
| Mole | | | | | | | | | |
| Fractions | | | | | | | | | |
| CH4 | | 0.95 | 0.00 | 0.24 | 0.01 | 0.00 | 0.00 | 0.10 | 0.00 |
| C2H6 | | 0.02 | 0.00 | 0.00 | 0.00 | 0.00 | 0.00 | 0.00 | 0.00 |
| C3H8 | | 0.01 | 0.00 | 0.00 | 0.00 | 0.00 | 0.00 | 0.00 | 0.00 |
| O2 | | 0.00 | 0.00 | 0.00 | 0.00 | 0.00 | 1.00 | 0.09 | 0.00 |
| CO2 | | 0.00 | 0.20 | 0.01 | 0.10 | 0.00 | 0.00 | 0.00 | 0.02 |
| H2O | | 0.00 | 0.08 | 0.03 | 0.21 | 1.00 | 0.00 | 0.02 | 0.07 |
| HE | | 0.00 | 0.00 | 0.00 | 0.00 | 0.00 | 0.00 | 0.00 | 0.00 |
| H2 | | 0.00 | 0.04 | 0.56 | 0.37 | 0.00 | 0.00 | 0.44 | 0.53 |
| CO | | 0.00 | 0.21 | 0.05 | 0.12 | 0.00 | 0.00 | 0.14 | 0.21 |
| N2 | | 0.02 | 0.47 | 0.09 | 0.18 | 0.00 | 0.00 | 0.20 | 0.18 |

Use of this syngas in the DR furnace was effective in reducing the iron ore to Direct Reduced Iron. The amount of syngas (CPO-out) reported in Table 10 was suitable to produce 1 ton of Direct Reduced Iron in the DR furnace.

### Example 8: Syngas Production from Natural Gas, Oxygen (O₂/C=0.84), Steam (S/C=0.06), Recycled Gas from the DR Furnace, BFG and COG (CO₂/C=0.21)

Natural Gas was fed to the CPO reactor with recycled DRG, BFG and COG in a process as shown in FIG. 4. Water and part of the CO₂ were removed from the DRG before being mixed to the hydrocarbon stream. The Hydrocarbon mixture was then preheated at 400° C. before entering the CPO reactor. Syngas was produced at 3 bar and 980° C. with a value of R═8.77 v/v.

TABLE 11

| | | | | | | | | CP | CPO- |
|---|---|---|---|---|---|---|---|---|---|
| | Units | NG | BFG | COG | DRG | Steam | O2 | O-in | out |
| Temperature | ° C. | 25 | 70 | 25 | 300 | 220 | 25 | 400 | 980 |
| Pressure | bar | 5 | 5 | 5 | 1.5 | 5 | 5 | 5 | 3 |
| Average | | 16.9 | 29.4 | 10.8 | 17.7 | 18.0 | 32.0 | 15.6 | 13.8 |
| MW | | | | | | | | | |
| Mole | kmol/ton_{—} | 6.5 | 3.5 | 6.6 | 97.1 | 0.0 | 7.6 | 84.1 | 94.6 |
| Flows | DRI | | | | | | | | |
| Mole | | | | | | | | | |
| Fractions | | | | | | | | | |
| CH4 | | 0.95 | 0.00 | 0.24 | 0.01 | 0.00 | 0.00 | 0.10 | 0.00 |
| C2H6 | | 0.02 | 0.00 | 0.00 | 0.00 | 0.00 | 0.00 | 0.00 | 0.00 |
| C3H8 | | 0.01 | 0.00 | 0.00 | 0.00 | 0.00 | 0.00 | 0.00 | 0.00 |
| O2 | | 0.00 | 0.00 | 0.00 | 0.00 | 0.00 | 1.00 | 0.09 | 0.00 |
| CO2 | | 0.00 | 0.20 | 0.01 | 0.11 | 0.00 | 0.00 | 0.02 | 0.02 |
| H2O | | 0.00 | 0.08 | 0.03 | 0.21 | 1.00 | 0.00 | 0.01 | 0.07 |
| HE | | 0.00 | 0.00 | 0.00 | 0.00 | 0.00 | 0.00 | 0.00 | 0.00 |
| H2 | | 0.00 | 0.04 | 0.56 | 0.38 | 0.00 | 0.00 | 0.46 | 0.53 |
| CO | | 0.00 | 0.21 | 0.05 | 0.14 | 0.00 | 0.00 | 0.19 | 0.27 |
| N2 | | 0.02 | 0.47 | 0.09 | 0.14 | 0.00 | 0.00 | 0.12 | 0.11 |

Use of this syngas in the DR furnace was effective in reducing the iron ore to Direct Reduced Iron. The amount of syngas (CPO-out) reported in Table 11 was suitable to produce 1 ton of Direct Reduced Iron in the DR furnace.

### Example 9: Syngas Production from Natural Gas, Oxygen (O₂/C=0.72), Steam (S/C=0.20), Recycled Gas from the DR Furnace and COG (CO₂/C=0.01)

Natural Gas was fed to the CPO reactor with recycled DRG and COG in a process as shown in FIG. 4. Water and CO₂ were removed from the DRG before being mixed to the hydrocarbon stream. The Hydrocarbon mixture is then preheated at 400° C. before entering the CPO reactor. Syngas was produced at 3 bar and 980° C. with a value of R═10.35 v/v.

TABLE 12

| | | | | | | | CPO- | CPO- |
|---|---|---|---|---|---|---|---|---|
| | Units | NG | COG | DRG | Steam | O2 | in | out |
| Temperature | ° C. | 25 | 70 | 300 | 220 | 25 | 400 | 980 |
| Pressure | bar | 5 | 5 | 1.5 | 5 | 5 | 5 | 3 |
| Average | | 16.9 | 10.8 | 15.4 | 18.0 | 32.0 | 12.1 | 10.2 |
| MW | | | | | | | | |
| Mole | kmol/ton_{—} | 6.2 | 6.2 | 74.3 | 1.7 | 6.8 | 61.6 | 73.4 |
| Flows | DRI | | | | | | | |
| Mole | | | | | | | | |
| Fractions | | | | | | | | |
| CH4 | | 0.95 | 0.24 | 0.02 | 0.00 | 0.00 | 0.15 | 0.00 |
| C2H6 | | 0.02 | 0.00 | 0.00 | 0.00 | 0.00 | 0.00 | 0.00 |
| C3H8 | | 0.01 | 0.00 | 0.00 | 0.00 | 0.00 | 0.00 | 0.00 |
| O2 | | 0.00 | 0.00 | 0.00 | 0.00 | 1.00 | 0.11 | 0.00 |
| CO2 | | 0.00 | 0.01 | 0.12 | 0.00 | 0.00 | 0.00 | 0.02 |
| H2O | | 0.00 | 0.03 | 0.29 | 1.00 | 0.00 | 0.03 | 0.07 |
| HE | | 0.00 | 0.00 | 0.00 | 0.00 | 0.00 | 0.00 | 0.00 |
| H2 | | 0.00 | 0.56 | 0.44 | 0.00 | 0.00 | 0.55 | 0.67 |
| CO | | 0.00 | 0.05 | 0.11 | 0.00 | 0.00 | 0.13 | 0.22 |
| N2 | | 0.02 | 0.09 | 0.02 | 0.00 | 0.00 | 0.03 | 0.02 |

Use of this syngas in the DR furnace was effective in reducing the iron ore to Direct Reduced Iron. The amount of syngas (CPO-out) reported in Table 12 was suitable to produce 1 ton of Direct Reduced Iron in the DR furnace.

### Example 10: Syngas Production from Natural Gas, Oxygen (O₂/C=0.79), Steam (S/C=0.05), Recycled Gas from the DR Furnace and COG (CO₂/C=0.24)

Natural Gas was fed to the CPO reactor with recycled DRG and COG in a process as shown in FIG. 4. Water and part of the CO₂ were removed from the DRG before being mixed to the hydrocarbon stream. The Hydrocarbon mixture is then preheated at 400° C. before entering the CPO reactor. Syngas was produced at 3 bar and 980° C. with a value of R═8.90 v/v.

TABLE 13

| | | | | | | | CPO- | CPO- |
|---|---|---|---|---|---|---|---|---|
| | Units | NG | COG | DRG | Steam | O2 | in | out |
| Temperature | ° C. | 25 | 70 | 300 | 220 | 25 | 400 | 980 |
| Pressure | bar | 5 | 5 | 1.5 | 5 | 5 | 5 | 3 |
| Average | | 16.9 | 10.8 | 16.5 | 18.0 | 32.0 | 14.0 | 12.2 |
| MW | | | | | | | | |
| Mole | kmol/ton_{—} | 6.6 | 6.6 | 87.9 | 0.3 | 7.5 | 74.7 | 86.1 |
| Flows | DRI | | | | | | | |
| Mole | | | | | | | | |
| Fractions | | | | | | | | |
| CH4 | | 0.95 | 0.24 | 0.01 | 0.00 | 0.00 | 0.12 | 0.00 |
| C2H6 | | 0.02 | 0.00 | 0.00 | 0.00 | 0.00 | 0.00 | 0.00 |
| C3H8 | | 0.01 | 0.00 | 0.00 | 0.00 | 0.00 | 0.00 | 0.00 |
| O2 | | 0.00 | 0.00 | 0.00 | 0.00 | 1.00 | 0.10 | 0.00 |
| CO2 | | 0.00 | 0.01 | 0.13 | 0.00 | 0.00 | 0.03 | 0.02 |
| H2O | | 0.00 | 0.03 | 0.24 | 1.00 | 0.00 | 0.01 | 0.07 |
| HE | | 0.00 | 0.00 | 0.00 | 0.00 | 0.00 | 0.00 | 0.00 |
| H2 | | 0.00 | 0.56 | 0.42 | 0.00 | 0.00 | 0.51 | 0.59 |
| CO | | 0.00 | 0.05 | 0.16 | 0.00 | 0.00 | 0.18 | 0.27 |
| N2 | | 0.02 | 0.09 | 0.04 | 0.00 | 0.00 | 0.05 | 0.04 |

Use of this syngas in the DR furnace was effective in reducing the iron ore to Direct Reduced Iron. The amount of syngas (CPO-out) reported in Table 13 was suitable to produce 1 ton of Direct Reduced Iron in the DR furnace.

1-15. (canceled)

16. A method for the reduction of iron ores with a direct reduction process carried out in a direct reduction furnace utilizing synthesis gas, the method comprising:
producing synthesis gas with a Short Contact Time-Catalytic Partial Oxidation process; and
performing the Short Contact Time-Catalytic Partial Oxidation process in a reactor that uses a gaseous hydrocarbon feedstock comprising direct reduction gas (DRG) produced in a direct reduction furnace and an oxidant comprising one or more of oxygen, enriched air, and air.

17. The method of claim 16, wherein the gaseous hydrocarbon feedstock fed to the reactor comprises steam.

18. The method of claim 16, wherein the gaseous hydrocarbon feedstock fed to the reactor further comprises one or more of: natural gas; CO₂; a purge gas; an off-gas produced by refining and/or other chemical and petrochemical processes; an associated gas to an oil reservoir; and a biogas having a biomass origin.

19. The method of claim 16, wherein the gaseous hydrocarbon feedstock fed to the reactor further comprises one or more of: a blast furnace gas; and a coke oven gas produced in a process for iron ores reduction utilizing a blast furnace.

20. The method of claim 19, wherein a blast furnace gas percentage in the hydrocarbon reactant mixture in the reactor is from 0 to 60% v/v.

21. The method of claim 19, wherein a content of coke oven gas in the hydrocarbon reactant mixture in the reactor is from 0 to 60%.

22. The method of claim 21, wherein a sum of the blast furnace gas and of the coke oven gas in the hydrocarbon reactant feedstock in the reactor is from 0 to 80%.

23. The method of claim 16, wherein:
the oxidant fed to the reactor comprises oxygen produced with one or more of alkaline electrolysis, polymer electrolyte membrane electrolysis, and solid oxide electrolysis; and
hydrogen that is co-produced by the electrolysis is added to the produced synthesis gas.

24. The method of claim 23, wherein the hydrogen co-produced by the electrolysis, and further carbon monoxide co-produced by the electrolysis, are included partially or completely to the reactant mixture fed to the reactor.

25. The method of claim 16, wherein the direct reduction gas contains CO₂ and a part of the CO₂ is separated from the direct reduction gas before its use in the reactor.

26. The method of claim 25, wherein the CO₂ recovered from the direct reduction gas is utilized in processes of carbon capture and utilization and/or of carbon capture and storage.

27. The method of claim 16, wherein syngas production via the Short Contact Time —Catalytic Partial Oxidation process is utilized in plants integrating the direct reduction process and a blast furnace reduction of iron ores.

28. The method of claim 27, wherein the iron produced with the direct reduction process is partially or entirely fed to a blast furnace unit.

29. The method of claim 16, wherein operating conditions for the Short Contact Time-Catalytic Partial Oxidation process comprise:
inlet temperatures of the feedstock to the reactor from 100 to 550° C.;
outlet temperatures of the gaseous streams produced by the reactor from 650 to 1100° C.;
inlet pressure of the reactant mixture in the reactor from 15 to 2 kg/cm²;
O₂/C v/v (moles of oxygen molecules vs. moles of carbon atoms included in the hydrocarbon compounds) in the reactant mixture in the reactor from 0.3 to 0.75 v/v;
S/C v/v (moles of steam vs. moles of carbon atoms included in the hydrocarbon compounds) from 0.0 to 1.5 v/v;
CO₂/C v/v (moles of CO₂ vs. moles of carbon atoms included in the hydrocarbon compounds) from 0.0 to 1.0 v/v.

30. The method of claim 29, wherein the sum of the blast furnace gas and of the coke oven gas in the hydrocarbon reactant feedstock in the reactor is from 0 to 80% v/v.

31. The method of claim 30, wherein the sum of the blast furnace gas and of the coke oven gas in the hydrocarbon reactant feedstock in the reactor is from 15 to 60% v/v.

32. The method of claim 16, wherein a steam content in the produced synthesis gas is lower than 10% v/v, and a ratio R═(CO+H₂)/(CO₂+H₂O) is higher than 3 v/v.

33. The method of claim 31, wherein the steam content in the produced synthesis gas is below 7% v/v.

34. The method of claim 31, wherein the ratio R═(CO+H₂)/(CO₂+H₂O) is higher than 7 v/v.
